(19) United States
(12) Patent Application Publication
(10) Pub. No.: US 2009/0063197 A1
(43) Pub. Date: Mar. 5, 2009

(54) Method and system for billing and payment for medical services

(76) Inventor: Michael J. Lisle, Lincolnwood, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/897,628

(22) Filed: Aug. 31, 2007

(51) Int. Cl. G06Q 40/00; G06F 17/30; G06F 17/40

(52) U.S. Cl. 705/4; 705/40

(57) ABSTRACT

Methods and systems are disclosed for processing a claim for healthcare services where the patient that has an HSA or HRA. A machine readable health card stores special identification data that serves as a link to the HSA or HRA. That data is transmitted to a transaction processor at the time medical services are rendered. The provider sends a statement for services rendered to the insurance carrier, which adjudicates the claim, determining how much is due the provider and how much of that amount is due from the patient as a result of co-payments and/or unmet deductible. This advice is electronically transmitted to the provider and to the transaction processor. The transaction processor merges the patient data with the advice. The amount owed by the patient is transmitted to the institution holding the HSA, which issues payment of that amount directly to the provider from the patient's HSA.

### FIELD OF THE INVENTION

The present invention generally relates to a method and system for processing billing and payment for medical services, and more particularly to processing the same when the patient has a health insurance policy with a deductible and the patient also has a Health Savings Account as defined by U.S. Tax law (“HSA”), or a Health Reimbursement Arrangement as defined by U.S. Tax law (“HRA”) or similar account, wherein the deductible may or may not have been met and where a discount might be due the patient, based on a reimbursement agreement between the health-care service provider and the insurance carrier.

### BACKGROUND OF THE INVENTION

Currently, when an insured patient requests and/or receives medical services from a healthcare provider, such as a hospital or a doctor in private practice, a behind-the-scenes process is initiated in which information is collected, transmitted, and variously aggregated and/or analyzed. One goal of this process is to effect the proper allocation, collection, and distribution of monetary funds among the parties involved.

At the beginning of the process, when medical service is initially requested or rendered, the patient may present to the healthcare provider an identification card issued by an insurance carrier. Based on the information disclosed by the identification card, the healthcare provider currently has no practical means of immediately and accurately determining what medical services the patient might be insured or eligible for. For example, the healthcare provider is typically unable to immediately determine if the insurance carrier has dropped coverage of the patient in the intervening time between issuance of the identification card and the current request for medical services. Further, the healthcare provider is unable to, in a practical manner, immediately determine whether that patient has met the deductible provisions applicable under his or her insurance policy and/or what co-payment provisions might be applicable for the currently requested medical services. Both of these provisions affect the prompt payment or reimbursement of the healthcare provider for services rendered. Further, the patient may request or require a medical service that is subject to a reduced-rate reimbursement agreement between the healthcare provider and the insurance carrier. Such agreements are common and such an agreement may affect the billed cost and/or payment of the medical service. As a practical matter, it is typically infeasible for a healthcare provider to prospectively calculate the actual impact of any such an agreements at the time services are rendered; consequently, the healthcare provider is unable to accurately bill and collect from the patient at that time.

Typically, a patient's insurance carrier will determine its financial responsibility for medical services provided to the patient based on the insurance policy that is in effect at the exact time the insurance carrier processes the healthcare provider's bill for such services. The insurance carrier will determine the extent to which deductible provisions have been met as of the time the bill is presented. The carrier will further make any adjustments to the bill based on normative billing practices and payments for the specific services rendered to the patient. Finally, the insurance carrier will apply any applicable reimbursement adjustments mandated by existing agreements between the carrier and the service provider. Only at this time will the exact remaining balance on the bill become known. At this point, the remaining balance can be billed to the next responsible party. If the next responsible party is another insurance carrier, that second carrier will then typically begin the same processing practices as it evaluates its financial responsibility. If the next responsible party is the patient or some guarantor, the healthcare provider will typically bill that person for the remaining balance.

When the patient (or guarantor) eventually receives the “final” bill for the remaining balance due to the healthcare provider, that patient typically has to reconstruct the history of the transaction in order to determine or verify that his or her financial obligation as detailed by the healthcare provider is indeed the same financial obligation as detailed by the insurance carrier. Currently, the insurance carrier typically sends an explanation of benefits (“EOB”) to both the healthcare provider and the patient when the insurance carrier adjudicates a particular claim. The EOB sent to the patient logically contains only information relevant to that particular patient or patient claim. The EOB report sent to the healthcare provider usually contains data on all transactions for all patients processed for that healthcare provider by that insurance carrier within the current processing/payment cycle. As such, the latter EOB report is not suitable to be shared with the patient because of Health Insurance Portability and Accountability Act (“HPAA”)-mandated privacy rights of other patients. Consequently, the healthcare provider simply bills the presumed proper amount to the patient, typically as indicated by the insurance carrier (it is the responsibility of the healthcare provider to reconcile any differences with the insurance carrier prior to billing the patient). In any event, receipt by the healthcare provider of the EOB from the insurance carrier is typically the triggering event for the healthcare provider to bill the patient.

To summarize the foregoing from the perspective of the patient involved in this process: (i) he or she will receive an EOB from the insurance carrier; (ii) sometime later, the patient will receive a bill from the healthcare provider; (iii) the patient will then have to assemble data relating to the originally provisioned medical services; (iv) next, the patient will have to ascertain that the amount he or she is asked to pay is consistent with normal billing practices in force; and (v) finally, the patient must determine whether he or she has received the benefit of discounts negotiated between the healthcare provider and the insurance carrier. In other words, the patient must verify that he or she has received the benefit of the insurance policy even before he or she has met the deductible portion existing under that policy.

The remainder of this section describes some elements of the foregoing process in greater detail and provides further description of the framework in which the present invention may operate. In 1986 the U.S. Health Care Financing Administration (“HCFA”), which had program responsibility for Medicare, changed its then twenty-year-old practice of payment for medical services delivered in hospitals to inpatients. In the interest of containing spiraling increases in the cost of medical care, HCFA introduced a system in which payment was premised on the reason(s) for admission. In the absence of truly unusual cases, it provided for a prospective payment system, wherein a known reimbursement would apply based on the reason(s) for admission, which reason(s) resulted in the case being categorized according to a diagnostically related grouping (“DRG”). This new policy resulted in a significant loss of reimbursement for hospitals, which HCFA promised to mitigate by lowering administrative costs, particularly those related to billing and collecting from Medicare.

As a step toward mitigating costs, HCFA required all Medicare bill processing contractors, so-called fiscal intermediaries, to accept all billing in electronic form. HCFA claimed that such a move would create considerable efficiency in this high-cost activity. Moreover, it was mandated that these same fiscal intermediaries provide reporting on actions taken on the cases in electronic form as well. Most of the Medicare contractors were various State Blue Cross programs and they were also the primary writers of secondary insurance policies; i.e., they provided coverage for costs not covered by Medicare. In those cases they would accept electronic billing from hospitals for Medicare patients, and they would automatically “cross-over” remaining balances, for those patients that they also covered under secondary policies, to their Blue Cross claim adjudication units. Those actions of billing the transactions electronically plus automatic cross-over billing truly did save administrative costs for hospitals in billing and collecting, but just for those types of cases.

Blue Cross recognized that it was saving considerable sums itself by not having to manually enter or work with the claim data, and it strongly encouraged hospitals to submit all claims electronically, whether for Medicare cases or for patients whose primary coverage was provided by Blue Cross. Other insurance carriers followed suit; indeed, the National Electronic Insurance Clearinghouse was formed by seven major carriers to promote and facilitate electronic claims not only from hospitals but from other medical service providers as well, such as physicians and laboratories. The resulting Electronic Media Claims quickly became the normative billing practice for medical services.

One aspect of processing healthcare claims included the processing of patient portions, i.e., payments or contributions to the healthcare provider by the treated, insured patient. For example, insured patients would commonly be responsible for a deductible, where the deductible amount was the amount the patient would have to pay out-of-pocket for healthcare expenses before the insurance carrier would begin covering the remaining costs Until fairly recently, deductibles for people covered by commercially available health policies were fairly minimal: for example, $250 annually for individuals and $500 for families were commonly encountered deductible amounts. As another example of patient portions, insured patients were also sometimes responsible for out-of-pocket co-payments made to the healthcare service provider at or near the time of service. These co-payments were also fairly minimal: for example, $20 per unique visit to a single healthcare provider. Over time, co-payments became more common as insurance carriers attempted to control what they saw as over utilization of healthcare services on the part of some of their insured patients.

In the past, hospitals and some other healthcare providers have often overlooked collecting patient portions from patients. However, it has became increasingly important to collect these patient portions as deductibles have increased, co-payments have became more commons, and lower overall reimbursement to the healthcare provider has been negotiated by insurance carriers under so-called managed care contracts. Important to recognize in this context is that insurance carriers negotiated lower total reimbursement for services, regardless of whether the insurance carriers paid for those services or whether payment arose, in whole or in part, from patients through their deductible and/or co-payment provisions.

A relatively recent move toward “consumerism” in health care is further fueled by tax incentivized Health Savings Accounts (“HSAs”) or their equivalent, and insurance premium reductions offered by insurance carriers to encourage patients to take greater control of purchasing decisions. Both of these efforts involve patients incurring more personal financial exposure through higher deductible amounts and/or co-payments, which in theory make patients less willing to incur costs that don't seem to have direct benefit. By extension, this should result in a substantial reduction to the cost of coverage. A similar result is seen with Health Reimbursement Arrangements, wherein employers provide pre-tax payments to their employees from which those employees pay for their own insurance coverage and/or out-of-pocket medical expenses.

What is being seen now is that deductible provisions have expanded to a point of ten times their previous levels. Indeed most patients will not exceed their deductibles in their annual health care expenses. However, the insurance carriers must still be billed because providers usually have no practical way to know if a patient has reached his or her deductible at the time of service. Further, the insurance carriers must apply the current charge against the remaining deductible. Finally still, agreed-upon reimbursement algorithms, including discount rates, are frequently applied by the insurance carriers to the charges billed to a patient for healthcare services and the discounted amount payable by the patient and due to the healthcare provider needs to be made known to the patient.

The foregoing reimbursement algorithm or procedure typically involves the insurance carrier applying whatever contractual provision and/or reimbursement methodology it has negotiated with the healthcare service provider to the bill for healthcare services for which reimbursement is sought. These contractual provisions and methodologies are often quite complex. Examples of typical provisions or methodologies can include, but are not limited to: percentage discounts; fixed rates (which are usually considerably lower than the billed rate; also known as “usual and customary” rates); all-inclusive per diem rates, modified per diem rates, wherein some specific services may be paid additionally; per case rates; reimbursement according to diagnostically related groupings (“DRGs”); reimbursement according to Ambulatory Surgical Groupings or Classes or Classifications (“ASCs”); and other methodologies, all of which may be subject to certain stop-loss and/or carve-out provisions.

Also within the reimbursement process, there are usually additional policies and practices applicable to billing procedures that are applied by insurance carriers that, for example, serve to further reduce the agreed-on reimbursement. For example, for Medicare Intermediaries, these procedures are termed Local Medical Review procedures (“LRMs”). Many healthcare providers, such as hospitals, cannot perform any such reduction calculation on charges incurred until all charges for any encounter or admission are known. Even then, some agreements further aggregate charges or do not allow certain specific charges. Reimbursement due to other types of healthcare providers may be less complicated to calculate, but also may or may not be subject to some reduction.

Another common policy and practice is for insurance carriers to enact billing procedures that are intended to catch abusive billing practices, whether intentional or not. Additionally, most reimbursement contracts between insurance carriers and healthcare providers are subject to non-disclosure agreements, thus making it difficult to share information among more than a few parties. As a result of these interlacing elements of the reimbursement process, the algorithms behind these various billing procedures can be so complicated and so varied that calculation without special computer programs and access to confidential information may be, as a practical matter, impossible or at least implausible.

Essentially, healthcare providers must perform all the steps they previously performed, but which no longer directly produce payment. Currently, they must look to billing or invoicing the patient in order to collect the patient payment portion. Unfortunately, patients generally cannot be billed electronically, nor can patients easily make payments electronically, as in the previous manner that had been so cost-efficient for payments by insurance carriers to medical service providers. Consequently, bad debt expense can be expected to rise as a result. In the end, these added costs will have to be recouped, and the cost of medical care to consumers can be expected to increase still further.

### SUMMARY OF THE INVENTION

An improved system and method for medical providers billing and collecting patient portions from patients, particularly those with high-deductible insurance policies and health savings accounts or health reimbursement arrangements, is provided by the present invention. The invention decreases costs, and expedites the processing of both bills and collections.

A further aspect and advantage of the invention is to provide such a system and method that helps to ensure that patients pay no more for medical services than the presumably lower prices their insurance carriers have negotiated with the various healthcare service providers and to protect the patients from abusive billing practices.

It will be understood that the term “patient” as used herein is not only referencing a party who is being treated, but is intended to encompass any person or legal entity that might stand in the place of the actual person for whom the medical services are being provided, i.e., the party who will be obligated to pay the portion of the billed services not being reimbursed by the insurance carrier.

In one aspect of the invention, the system and method of the invention is capable of utilizing those existing aspects of the health care infrastructure that necessarily employ specific procedures that must occur in each and every healthcare service transaction that is subject to health insurance coverage, particularly those under high-deductible plans and where payment for the residual amount net of insurance payment, if any, is to be reimbursed from an HSA or HRA; and more particularly where such payment may be subject to a reduction pursuant to a reimbursement contract between the service provider and the insurance carrier. Such transactions cover the vast majority of those between healthcare providers and patients with HSAs or HRAs, but are not limited to such cases.

More particularly with respect to the foregoing aspect of the invention, the procedures involved in reimbursement entail quantification of the exact amount of reimbursement agreed to contractually by the medical services provider (hospital, physician, laboratory or other provider), and the remaining deductible amount under the patient's insurance policy; the latter will not be known until the transaction is adjudicated by the patient's insurance carrier. The amount remaining under deductible provisions is a function of timing, i.e., when bills or statements are presented to insurance carriers. The invention thus contemplates that services from different providers delivered on the same day can be calculated against remaining deductibles at the exact moment they are processed by the carrier.

It will be understood that, while an HSA or HRA is a viable source of patient funds contemplated by this invention, other sources of patient funds are also contemplated. For example, the patient may choose to have the residual amount paid from a credit card account, a private bank account, a debit card account, or any other viable source of funds. References to HSA or HRA sources are made for exemplary purposes only and it shall be understood that any other viable source of patient funds, alone or in combination, may instead be substituted for the HSA or HRA, and such substitutions are indeed contemplated by the various embodiments of this invention.

In one preferred form of the invention, at the time the healthcare provider obtains insurance data from a patient, typically at the point in time of providing the health care service, the healthcare provider “swipes” or otherwise electronically reads a healthcard having machine readable data embedded thereon (e.g., within a magnetic strip, an RFID tag, or the like). The healthcard may be similar to a credit card, a key-chain card, or any other portable device capable of storing and conveying electronic information. The healthcard issuer may be, for example, a bank or other institution which holds, administers, or otherwise maintains the patient's HSA, HRA, or other patient fund account. That action at the healthcare provider may alert the healthcard issuer or other transaction processor that a transaction is forthcoming from that healthcare provider, which will occur subsequent to prior adjudication by the insurance carrier or carriers. That is, there is relational data on the healthcard that causes a message to be electronically transmitted to a processing node (station, computing facility or the like), which in turn queues (or otherwise relates) the transaction with respect to the patient's HSA or HRA.

In this preferred embodiment, the healthcare provider electronically bills the insurance carrier for the services rendered (services being used herein to describe anything provided, included hardware, medicines, treatments, and so forth). When the insurance carrier adjudicates the claim (determines what is covered and what is not, what amount has been contractually agreed-on for those services, and what the patient's responsibility is), it may advise the healthcare provider via an industry standard electronic remittance advice (“ERA”) or the like. The insurance carrier may also issue the ERA to the healthcard issuer or other transaction processor. Alternatively or additionally, the route to the healthcard issuer or other transaction processor may also be through the healthcare provider, who may upload the ERA or equivalent summary statement to the healthcard issuer or other transaction processor and/or to the insurance carrier, or other entity which otherwise performs some similar procedure.

Still in conjunction with this preferred embodiment, the insurance carrier's adjudication data is then merged with the initially gathered patient data, with the transaction formatted to any applicable industry standard for the electronic transmission of information and/or financial transactional data, e.g., the electronic funds transfer (“EFT”) industry standard. The merged data may then be sent to the patient's healthcard issuer or transaction processor. “Merges” is used in a broad sense, including also matching, linking or the like.

At this stage in the preferred embodiment, the patient's healthcard issuer causes funds to be sent, for example through an EFT, from the patient's financial account, such as the patient's HSA or HRA, to the healthcare provider's designated financial account, thereby paying the healthcare provider that portion of the services owed by the patient and not reimbursed by the insurance carrier. There may also be a related transaction in which the patient's healthcard issuer charges a linked cash advance account or some other form of funds, depending on the current balance in the patient's HSA or HRA.

It is contemplated that the present invention, in all embodiments, may require the application of all relevant benefits, as negotiated between the insurance carrier and the healthcare provider, as a criteria before the patient is billed. Commensurately, the healthcare provider may enjoy the benefit of automatic payment when that, and/or other, preconditions are met. All this may occur electronically, with no manual intervention required by any of the parties. It therefore substantially decreases costs.

Considering the invention in another form, a system and method for collecting payments from patients having healthcare insurance from an insurance carrier and an HSA or HRA provides a healthcard for a patient. The healthcard has data thereon in machine-readable form including relational data to an institution holding a patient's HSA or HRA. The healthcard may be read at a point where medical services are rendered by a healthcare provider. While a machine-readable card is contemplated, a less preferred but still effective step would involve manual input of the salient relational data. Processing a claim for reimbursement to the healthcare provider from the insurance carrier occurs. The processed claim may result in electronically transmitted advice to the healthcare provider, including a reimbursement portion from the insurance carrier and an amount owed by the patient. The amount owed by the patient may be transmitted to the institution, and the institution may issue payment of that amount owed directly to the healthcare provider from the patient's HSA or similar account.

Another embodiment of the invention includes a method and system for generating a payment from a patient to whom healthcare services have been, or are about to be, rendered by a healthcare provider. The patient has a healthcard, healthcare insurance from an insurance carrier, and a health savings account (HSA) or health reimbursement arrangement (HRA). A transaction processor or similar entity, device, or system of devices, including hardware and software, may receive from the healthcare provider an electronic transmission which includes data read from the patient's healthcard. The data includes relational data to an institution administering the patient's HSA or HRA. The transaction processor or equivalent may also receive from the insurance carrier an electronic transmission which includes a summary of information regarding the adjudication of a claim to the insurance carrier for the services rendered by the healthcare provider. The summary may also include an amount owed by the patient. The transaction processor or equivalent subsequently electronically transmits to the institution the amount owed by the patient. The transmission may include instructions to issue payment of the amount owed to the healthcare provider from the patient's HSA or HRA.

Another embodiment of the invention also includes a method and system for generating a payment from a patient to whom healthcare services have been, or are about to be, rendered by a healthcare provider. The patient has a healthcard, healthcare insurance from an insurance carrier, and a health savings account (HSA) or health reimbursement arrangement (HRA). The healthcare provider electronically reads the healthcard. The healthcard data includes relational data to an institution administering the patient's HSA or HRA. The healthcare provider may cause at least a portion of the data to be electronically transmitted to the insurance carrier. Subsequently, the healthcare provider may receive from the insurance carrier by electronic transmission a summary of information regarding the adjudication by the insurance carrier of the claim for the services provided by the healthcare provider. The summary may include a reimbursement portion from the insurance carrier. The healthcare provider may also receive from the institution by electronic funds transfer an amount owed by the patient. The source of funds may be the patient's HSA or HRA.

Another embodiment of the invention includes method and system for generating an electronic transmission to a transaction processor for purposes of generating a payment from a patient. The patient has a healthcard, healthcare insurance from an insurance carrier, and a health savings account (HSA) or health reimbursement arrangement (HRA). An insurance carrier may receive from a healthcare provider data read from the health card by electronic transmission. The healthcard data may include relational data to an institution administering the patient's HSA or HRA. The insurance carrier may adjudicate a claim for services by a healthcare provider, wherein the adjudication results in a summary of information which includes an amount owed by the patient. The insurance carrier may then transmit to a transaction processor by electronic transmission the amount owed by the patient and at least a portion of the health card data.

These and other aspects, objectives met, and advantages of the invention will be further understood upon consideration of the following description of various embodiments, taken in conjunction with the drawings, in which:

### BRIEF DESCRIPTION OF THE DRAWINGS

FIG. 1 is a flow diagram of a typical current medical billing and paying process;

FIG. 2 is a flow diagram of another typical current medical billing and paying process involving HSAs;

FIG. 3 is a flow diagram of a medical billing and paying method and system according to the present invention; and

FIG. 4 is a flow diagram of another embodiment of a medical billing and paying method and system according to the present invention.

### DETAILED DESCRIPTION OF EMBODIMENTS

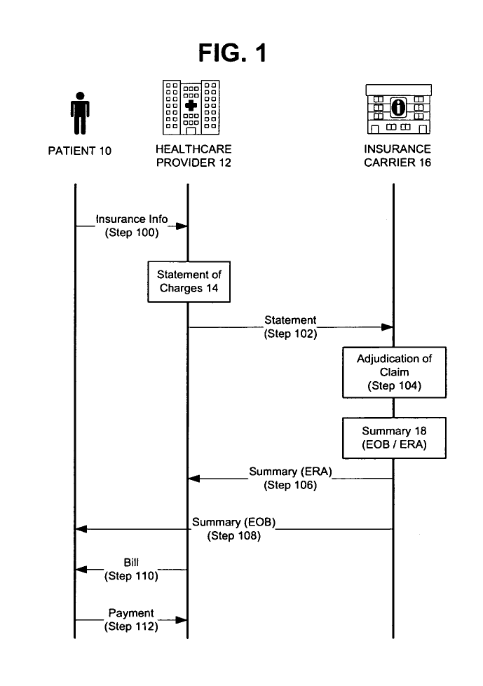

Before turning to some illustrative embodiments of the invention, it is useful to discuss how a transaction for billing and then paying for healthcare services is currently effected. Looking at FIG. 1, this figure depicts the typical process currently employed when a patient 10 seeks healthcare service from a healthcare provider 12, where such a patient 10 has medical insurance coverage. At or near the time healthcare service is provided, the healthcare provider 12 may take insurance information, such as policy data, from the patient 10 (Step 100). Subsequently, the healthcare provider 12 may assemble other healthcare data relevant to the healthcare service(s) provided, including but not limited to, medical indications for the service(s), the diagnosis, the actual services provided, the date(s) on which the services were provided, and the healthcare provider's charges for those services. From such an assembly of data, the healthcare provider may prepare a statement of charges 14. The statement 14 is prepared consistent with the requirements for billing for each type of healthcare provider 12 and/or for each insurance carrier 16. The healthcare provider 12 may then mail or electronically transmit the statement 14 to the responsible insurance carrier (Step 102).

The insurance carrier 16 may then adjudicate the bill or claim (Step 104), and provide a summary of its actions 18, which it sends to the healthcare provider 12 (Step 106) and to the policyholder whose coverage applies (Step 108). For explanatory purposes herein, the terms policyholder and patient 10 are considered interchangeable, though they may in fact be different persons or entities. For example, the policyholder may be a parent and the patient 10 may be an insured child of the policyholder.

The summary 18 may also be known as an Explanation of Benefits (“EOB”) when it is transmitted to the patient 10. The summary 18 is typically transmitted by mail when sent to the patient 10. Alternatively or additionally, the summary 18 may also be known as an Electronic Remittance Advice (“ERA”) when it is transmitted to the healthcare provider 16 or another party or entity. The summary 18 may be transmitted by mail or by electronic means when it is sent to the healthcare provider 16. Other components that may or may not be included on the summary 18 are the amount of charges from the healthcare provider 12, the amount allowed for those charges by the insurance carrier 16, what the insurance carrier 16 has calculated as an agreed-upon reimbursement based on a contract it has negotiated with the healthcare provider 12, what the insurance carrier 16 claims to be reasonable and customary charges for those services by other healthcare providers in the area, and/or the amount paid or to be paid by the insurance carrier 16 after deducting the remaining deductible for the patient 10 and/or after deducting any other so-called patient portion such as a co-payment. Finally, the summary 18 may include the amount due the healthcare provider 12 from the patient 10. This is the amount that the healthcare provider 12 can now collect from the patient 10, based on the terms of the contract between the healthcare provider 12 and the insurance carrier 16, or based on what the insurance carrier 16 claims to be reasonable and customary.

The healthcare provider 12 then prepares a bill for the patient 10, and typically mails it to the patient 10 (Step 110), with the expectation that the patient 10 will then mail back a check or provide some other form of payment in the requisite amount (Step 112). Usually the bill of Step 110 takes the form of a summary bill and does not include any explanation of the insurance carrier's 16 action in Step 108, in which the insurance carrier sent the patient 10 the summary 18, in the form of an EOB.

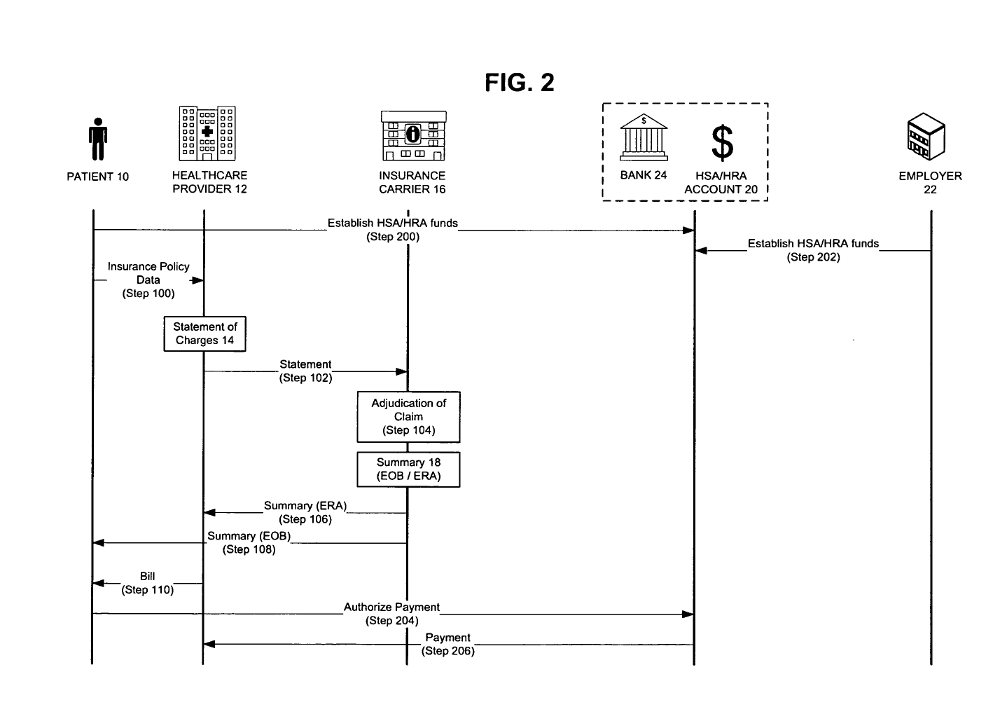

FIG. 2 depicts how the process becomes even more cumbersome under the present system with the use of HSAs. It becomes more complicated from the perspective of the patient, since now it includes funding the HSA and then distributing funds from that account for qualified medical expenses. At the outset of the process, the patient 10 (Step 200), and also typically the employer 22 (Step 202), establish the funds for the HSA 20 with some entity, such as a bank 24. The rest of the steps generally track what was described with respect to FIG. 1, except now the foregoing Step 112 is a two part step whereby the patient 10 authorizes the bank 24 to dispense the funds from the HSA 20 (Step 204) to pay the healthcare provider 12 (Step 206). For example, the patient 10 may write a check drawn on his account at the bank 24.

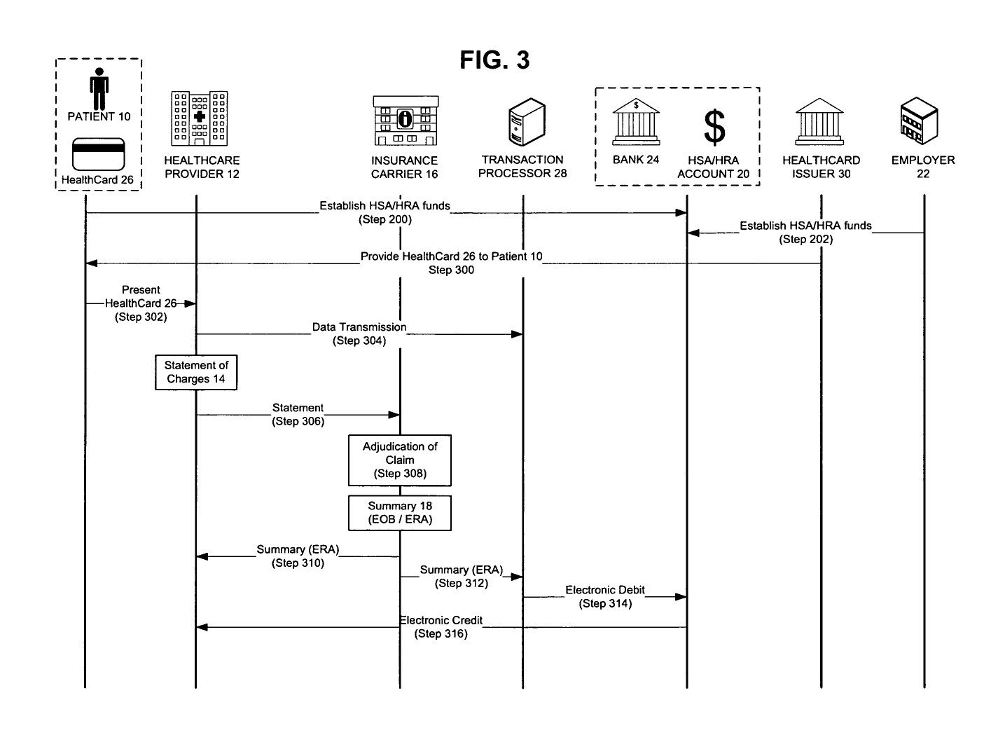

Now turning to the advantages achieved by the present invention over both the processes discussed with respect to FIGS. 1 and 2, in the embodiment of FIG. 3 the billing and payment process as carried out under the proposed system and method has a healthcard issuer 30 providing a healthcard 26 to the patient 10 (Step 300). The healthcard 26 contains certain identification and individual data that is related to the patient 10 and/or to an HSA 20. For example, the healthcard may contain the patient's 10 full name, address, and/or social security number or other uniquely identifying data and may also contain the routing and account number for the patient's 10 HSA 20. Other possibilities are hereinafter described. Information may be embedded in a magnetic strip, for instance, or in other preferably machine-readable media such as an RFID tag. The patient 10 may then present the health card 26 to the healthcare provider 12 (Step 302).

This first embodiment of the inventive system and method calls for the healthcard 26 to be swiped in a standard charge/debit card reader. Alternatively, the data in the healthcard 26 may be presented and read by other means, such as by an RFID system. Utilizing routing data embedded in the healthcard 26, the card reader transmits data from the healthcard 26 to a transaction processor 28 that is part of a network, such as the Internet (Step 304). The transaction processor 26 will then await further transactional data from the insurance carrier 16. This puts the transaction-in-progress essentially in a virtual queue. At or near the same time, the statement of charges 14 as billed by the healthcare provider 12 may be sent to the insurance carrier 16 (Step 306). The statement of charges 14 may also contain all or part of the data obtained from the healthcard 26.

The insurance carrier 16 then adjudicates the claim and provides a summary 18 of its actions, for example as an ERA, to the healthcare provider 12 (Step 310) and to the transaction processor (Step 312). It is contemplated that at regular intervals, the healthcare provider 12 transmits the summaries 18 for which there are transactions from the health card 26 to the transaction processor 28, which merges these transactions with those transmitted previously.

As to the transaction processor 28, it may take various forms known in the art. For example, the transaction processor 28 may be an ACCOORD system. Whatever the system may be, it operates to conclusively identify the patient 10 for purposes of adjudication and/or further communications regarding the patient 10. For example, the identities of the patient 10, as known to the healthcare provider 12 and the insurance carrier 16 may be quite different. At a minimum, the patient 10 may be the insured, the spouse of the insured, or a dependent child, and may therefore be referred to by the insurance carrier 16 under the insured's name (which quite conceivably may be a different surname). The patient 10 may be further identified as one of the foregoing relationships, but part of an affinity group, such as an employer. Finally, there may be considerable overlap or commonality of patient 10 or guarantor names seen by a particular healthcare provider 12, especially if that healthcare provider 12 serves specific cultural affinities wherein surnames and given names are highly repetitious. The ACCOORD system may use matching or merging techniques to consolidate data between a specific patient's 10 encounter with healthcare provider 12 and the adjudication by the responsive insurance carrier 16. This may be achieved by keeping the detail surrounding the patient 10 and his/her billing for services to the responsible insurance carrier 16 matched to the data swiped from the patient's healthcard 26 and to the carrier's adjudicatory response (the summary 18).

Following the receipt of the summary 18, the transaction processor 28 may issue an electronic debit or a request for an electronic debit to the bank 24 having the HSA 20 belonging to the patient 10 (as identified by the data from the patient's 10 healthcard 26) (Step 314). The bank 24 holding the HSA 20 may then forward an electronic credit (Step 316) to the healthcare provider 12, for example, by means of the banking industry standard fashion such as an Electronic Funds Transfer (EFT).

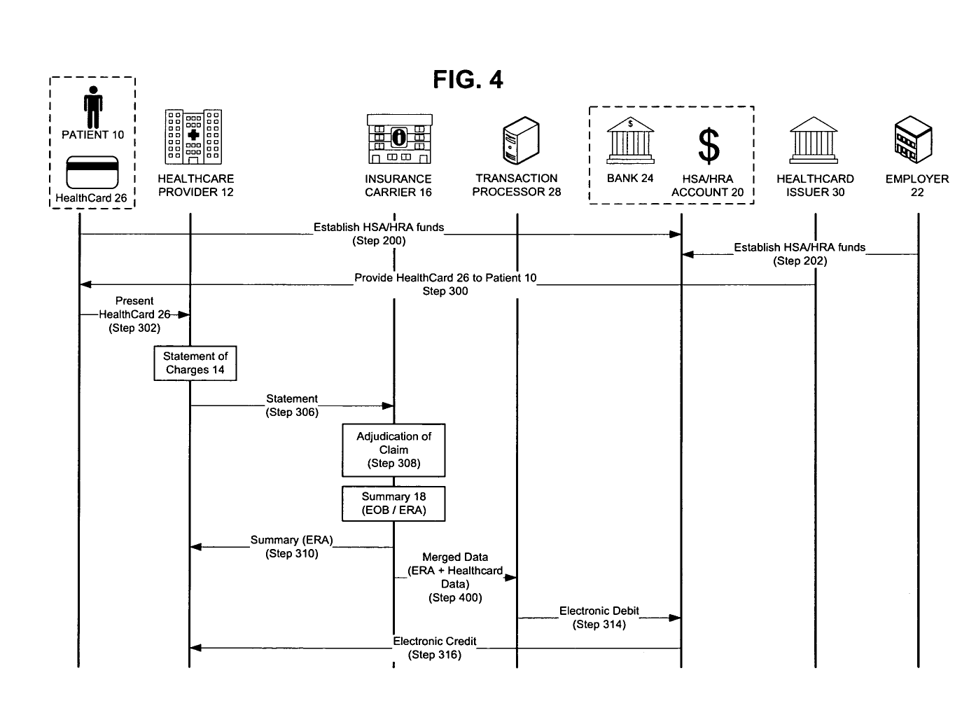

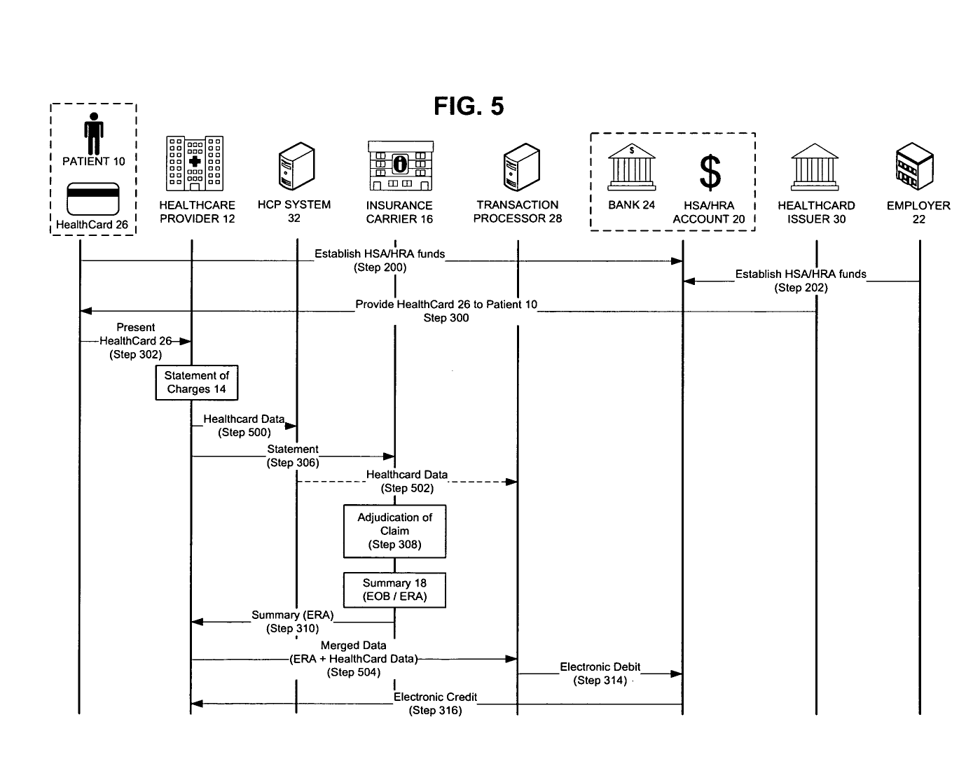

Turning to FIG. 4, a variation on the inventive concept is provided. Again, steps or entities described with respect to FIG. 3 are duplicated here in FIG. 4 using the same step designations. However, this second embodiment of the inventive system and process contemplates that, as in FIG. 3, data embedded in the healthcard 26 is transmitted to the insurance carrier 16 by the healthcare provider 12 at Step 306 as part of the statement 14, but unlike FIG. 3, the healthcard 26 data of FIG. 4 is not also transmitted to the transaction processor 28, as was accomplished in step 304 of FIG. 3. When the insurance carrier 16 adjudicates the claim at step 308, the insurance carrier 16 may then transmit merged data to the transaction processor 28 (Step 400). The merged data may consist of some or all of the healthcard 26 data received at step 306 and some or all of the summary 18. The transaction processor 28 may then issue a debit to the HSA account (Step 314), and so forth in the manner described with respect to FIG. 3 above.

In FIG. 5, a third embodiment of the system and method of the invention contemplates that the healthcare provider 12 does not transmit the healthcard 26 data to the insurance carrier 16 or the transaction processor as part of step 306 or step 304, but rather the healthcare provider 12 (or the card reader possessed by the healthcare provider 12) may transfer the healthcard 26 data to a computer system 32 (“HCP system”) under the control of the healthcare provider 12 (Step 500). The HCP system 32 may or may not transfer the data to a transaction processor 28 (step 502) before the claim to which it applies is adjudicated by the insurance carrier 16 to whom it is billed. With a merging node now at the point of the healthcare provider 12, the insurance carrier's 16 summary may now be sent to the healthcare provider 12, where it may then be merged with the patient's healthcard 26 data in manner as previously described, and then sent to the transaction processor 28. Steps 314 and 316 then follow, as in the previously described embodiments.

In another aspect of the invention, and particularly related to the queuing of transactions-in-progress, the invention further contemplates that the transaction processor 28 could generate a statement, such as for the patient 10, and alternatively or additionally for the healthcare provider 12, indicating what the status is likely to be of the patient's HSA in view of a given transaction. That is, with historical data from the insurance carrier 16 on prior treatment of a claim of the type undergoing adjudication, a probable summary EOB/ERA can be calculated. Adding in a step of data retrieval by the transaction processor 28 from the HSA holding institution 24, as to the amount in the HSA, the patient can then be apprised of how much the HSA will be diminished by the likely adjudication(s).

In yet another aspect of the invention, and in accordance with all described embodiments, the insurance carrier 16, transaction carrier 28, bank 24, or another entity may send a communication to the patient, for example via e-mail or another form of electronic transmission, that asks the patient 10 to authorize payment, prior to the step of electronically crediting (Step 316) the healthcare provider 12. The patient 10 may then authorize payment after receiving the communication. Additionally or alternatively, the patient 10 may preemptively authorize payment prior to receiving the communication. For example, the patient may preauthorize all payments or may selectively preauthorize payments based upon some criteria, such as the identity of the receiving healthcare provider 12. Accordingly, the electronic credit (Step 316) may not be accomplished until authorization is granted.

Thus, while the invention has been described herein with relation to certain embodiments and applications, those with skill in this art will recognize changes, modifications, alterations and the like which still come within the spirit of the inventive concept, and such are intended to be included within the scope of the invention as expressed in the following claims. For example, not all steps need occur, nor do all steps need to occur in the order in which they are described or shown with reference to the exemplary figures. For example, steps 200 and 202 need not occur in any particular order. Alternatively or additionally, either step 200 or step 202 may be left out as long as an HSA is established by someone for the patient 10. As further examples, the following steps need occur in no specific order: steps 304 and 306; steps 310 and steps 312; and steps 306 and 502. Considering other examples, bank 24 need not be a bank, but may rather be some other institution that maintains or administers HSAs or HRAs. Also, healthcard issuer 30 need not be a separate entity, but may instead be part of bank 24, insurance carrier 16, transaction processor 28, or healthcare provider 12.

What is claimed is:

1. A method for collecting a payment from a patient, wherein said patient has healthcare insurance from an insurance carrier and said patient has a health savings account (HSA) or health reimbursement arrangement (HRA), comprising:
providing a health card for said patient, said health card including relational data to an institution holding said patient's HSA or HRA;
reading said health card at a point where healthcare services are rendered by a healthcare provider but prior to adjudication of a claim for said services by said insurance carrier, said relational data being associated with a claim for service;
transmitting said relational data and at least some aspect of said claim for services to said institution;
processing said claim for reimbursement to said healthcare provider from said insurance carrier, said processed claim resulting in electronically transmitted advice to said healthcare provider including a reimbursement portion from said insurance carrier and an amount owed by said patient; and
transmitting to said institution said amount owed by said patient, and issuing payment of said amount owed to said healthcare provider from said patient's HSA or HRA.

2. A method for collecting payments from a party having responsibility for paying a portion of a medical bill from a healthcare provider, where part of said bill is covered by medical insurance from an insurance carrier and part is to be paid from a health savings account (HSA) or a health reimbursement arrangement (“HRA”), comprising:
providing a health card for a patient, said card having data thereon including relational data to an institution holding said patient's HSA or HRA;
reading said health card to retrieve said data;
processing a claim for reimbursement to said healthcare provider from said insurance carrier, said processed claim resulting in electronically transmitted advice to said healthcare provider including a reimbursement portion from said insurance carrier and an amount owed by said patient;
merging said retrieved data with said advice;
using said data for transmitting to said institution said amount owed by said patient, and issuing payment of said amount owed to said healthcare provider from said patient's HSA or HRA.

3. The method of claim 2 wherein said health card having data thereon has said data in machine-readable form.

4. The method of claim 3 wherein said step of reading said health card occurs at a point where medical services are rendered by said healthcare provider.

5. The method of claim 4 wherein said step of merging said data occurs with said insurance carrier.

6. The method of claim 4 wherein said step of merging said data occurs with said healthcare provider.

7. The method of claim 2 wherein said HSA or HRA is instead a credit card account, a non-HSA private bank account, or a debit card account

8. A method for collecting payments from a party having responsibility for paying a portion of a medical bill from a healthcare provider, where part of the bill is covered by medical insurance from am insurance carrier and part is to be paid from a health savings account (HSA) or health reimbursement arrangement (“HRA”), comprising:
providing a health card for a patient, said card having data thereon including relational data to an institution holding said patient's HSA or HRA;
reading said health card to retrieve said data;
transmitting said data to a transaction processor which is in communication with said patient's HSA or HRA;
processing a claim for reimbursement to said healthcare provider from said insurance carrier, said processed claim resulting in electronically transmitted advice to said healthcare provider and also to said transaction processor including a reimbursement portion from said insurance carrier and an amount owed by said patient;
merging said retrieved data with said advice;
using said data for transmitting to said institution said amount owed by said patient, and issuing payment of said amount owed to said healthcare provider from said patient's HSA or HRA.

9. A method for generating a payment from a patient, wherein said patient has a health card, healthcare insurance from an insurance carrier, and a health savings account (HSA) or health reimbursement arrangement (HRA), comprising:
receiving from a healthcare provider data read from said health card by electronic transmission, wherein said health card data includes relational data to an institution administering said patient's HSA or HRA;
receiving from said insurance carrier by electronic transmission a summary of information regarding the adjudication of a claim for said services by said insurance carrier, wherein the summary includes an amount owed by said patient; and
transmitting to said institution by electronic transmission said amount owed by said patient, wherein said transmission to said institution includes instructions to issue payment of said amount owed to said healthcare provider from said patient's HSA or HRA.

10. A method for collecting a payment from a patient, wherein said patient has a health card, healthcare insurance from an insurance carrier, and a health savings account (HSA) or health reimbursement arrangement (HRA), comprising:
electronically reading data from said health card, wherein said health card data includes relational data to an institution administering said patient's HSA or HRA;
transmitting at least a portion of said data by electronic transmission to said insurance carrier;
receiving from said insurance carrier by electronic transmission a summary of information regarding the adjudication of a claim for said services by said insurance carrier, wherein the summary includes a reimbursement portion from said insurance carrier; and
receiving from said institution by electronic funds transfer an amount owed by said patient, wherein the source of funds is said patient's HSA or HRA.

11. A method for generating an electronic transmission to a transaction processor for purposes of generating a payment from a patient, wherein said patient has a health card, healthcare insurance from an insurance carrier, and a health savings account (HSA) or health reimbursement arrangement (HRA), comprising:
receiving from a healthcare provider data read from said health card by electronic transmission, wherein said health card data includes relational data to an institution administering said patient's HSA or HRA;
adjudicating a claim for services by a healthcare provider, wherein such adjudication results in a summary of information which includes an amount owed by said patient; and
transmitting to a transaction processor by electronic transmission said amount owed by said patient and at least a portion of said health card data.
